(19) United States
(12) Patent Application Publication
(10) Pub. No.: US 2013/0327841 A1
(43) Pub. Date: Dec. 12, 2013

(54) MODULAR VEHICLE HEATER

(71) Applicant: Espar Products, Inc., Mississauga (CA)

(72) Inventor: VOLKER HOHENSEE, Mississauga (CA)

(73) Assignee: Espar Products, Inc., Mississauga (CA)

(21) Appl. No.: 13/899,886

(22) Filed: May 22, 2013

Related U.S. Application Data
(63) Continuation of application No. 12/050,574, filed on Mar. 18, 2008, now abandoned.

(51) Int. Cl. B60H 1/22

(52) U.S. Cl. CPC B60H 1/2212
USPC 237/12.3 A; 237/12.3 C

(57) ABSTRACT

Apparatus for heating a vehicle has a mounting plate adapted to be secured in a window frame of the vehicle. The mounting plate has an inside face, an opposed outside face, and openings extending between the outside face and the inside face. A combustion heater is mounted to the inside face of the mounting plate. The combustion heater is arranged to intake fresh air and expel exhaust through an opening or openings in the mounting plate. A fuel tank is mounted to the outside face of the mounting plate and a fuel line extends through an opening in the mounting plate to connect the fuel tank with a fuel supply port of the combustion heater. A modular heating apparatus is thus provided that may be installed in a vehicle window frame. The heating apparatus avoids the necessity to idle the vehicle engine to maintain a comfortable interior temperature in cold weather. It also avoids the necessity for permanent modifications such as installation of a heater.

### BACKGROUND OF THE INVENTION

The present invention relates generally to heating devices, and more particularly to a modular heating device for heating a vehicle.

Vehicles are frequently idled to maintain a comfortable interior temperature in cold weather. Idling a vehicle to maintain a comfortable interior cab temperature is inefficient, particularly so with a large commercial vehicle, given the large engines that are typical of such vehicles. Further, inefficient idling generates unnecessary emissions that are harmful to the environment.

These problems can be acute in the trucking industry where drivers frequently idle the engines in their vehicles overnight when sleeping in their vehicles in cold weather. In cold temperatures many trucks may be idling in close proximity, such as for example at a truck stop, degrading the air quality at the truck stop.

Certain truck stops have recently become anti-idling truck stops. At an anti-idling truck stop, drivers are prohibited from idling their vehicles for extended periods of time. Anti-idling requirements may be imposed by legislation in certain areas or voluntarily by truck stop operators. An anti-idling truck stop typically provides hook ups allowing vehicles to connect to an exterior source of power and heat to eliminate the necessity to idle a vehicle. Operators are typically charged an hourly fee for use of these hook ups. However, such facilities are expensive to establish, complicate snow removal, and have limited capacity. Limited capacity is problematic as operators of commercial vehicles may have restrictions upon how many hours they are permitted to operate a vehicle in a given time period, effectively prohibiting an operator from proceeding to another truck stop. In these circumstances, an operator may be forced to leave the truck stop premises and idle nearby to maintain a comfortable interior temperature in cold weather.

It is known to provide a source of heat that operates independently of a vehicle engine in order to maintain a comfortable interior temperature in cold weather. For example, it is known to install a permanent combustion air heater inside a vehicle interior with its own fuel supply. It is also known to install a coolant heating system to heat engine coolant and supply heat to a vehicle interior via the existing HVAC system of the vehicle without operating the vehicle engine. Additionally, it is known to supply a generator with fuel to supply electrical power to an in-vehicle heater.

The existing heat sources noted above suffer from certain disadvantages. More specifically, the permanent installation of air heaters, coolant heaters, or auxiliary power units is relatively complex and therefore expensive. Additionally, these types of heating systems, especially auxiliary power units, are relatively expensive to purchase. This has prevented widespread adoption, particularly in vehicles and fleets that do not regularly operate in cold weather.

The present invention aims to overcome some of the problems present in known vehicle heating systems.

### SUMMARY OF THE INVENTION

A modular heating apparatus is provided that may be installed in a vehicle window frame. The heating apparatus avoids the necessity to idle the vehicle engine to maintain a comfortable interior temperature in cold weather. It also avoids the necessity for permanent modifications such as installation of a heater. Such a heating apparatus can reduce fuel consumption and the associated operating costs in addition to reducing harmful emissions compared to idling the vehicle engine to maintain a comfortable interior temperature.

In accordance with the present invention, there is provided an apparatus for heating a vehicle, comprising: a mounting plate adapted to be secured in a window frame of the vehicle, the mounting plate having an inside face, an opposed outside face, and at least one opening extending between the outside face and the inside face; a combustion heater mounted to the inside face of the mounting plate, the combustion heater arranged to intake fresh air through one opening of the at least one opening and expel exhaust through one opening of the at least one opening; a fuel tank mounted to said outside face of the mounting plate and a fuel line extending through one opening of the at least one opening to connect the fuel tank with a fuel supply port of the combustion heater.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention:

FIG. 1 is an exterior side view of a vehicle heater made in accordance with an embodiment of the invention installed in a vehicle window frame.

FIG. 2 is an interior side view of the vehicle heater shown in FIG. 1 in isolation.

FIG. 3 is an end view of the vehicle heater shown in FIGS. 1 and 2.

FIG. 3A is a detail view showing a portion of the vehicle heater of FIGS. 1-3.

FIG. 4 is a perspective view of a portion of the vehicle heater of FIGS. 1-3.

FIG. 5 is a cross sectional view of the top edge of the mounting plate of the vehicle heater and the bottom edge of the vehicle window frame of FIG. 1.

FIG. 6 is a cross sectional view of the bottom edge of the mounting plate and the top edge of the vehicle window pane of FIG. 1.

FIG. 7 is a side view of a portion of the vehicle heater of FIG. 1 showing a laterally extendable wall in an extended position.

FIG. 8 is a side view of a portion of the vehicle heater of FIG. 1 showing the laterally extendable wall in a partially retracted position.

FIG. 9 is a side view of a mounting plate made in accordance with another embodiment of this invention.

FIG. 9A is a cross sectional view in the direction of 9A-9A shown in FIG. 9.

FIG. 9B is a cross sectional view of the top edge of the mounting plate shown in FIG. 9 and the bottom edge of a vehicle window frame.

FIG. 10 is a schematic side view of a combustion heater made in accordance with another embodiment of this invention.

### DETAILED DESCRIPTION

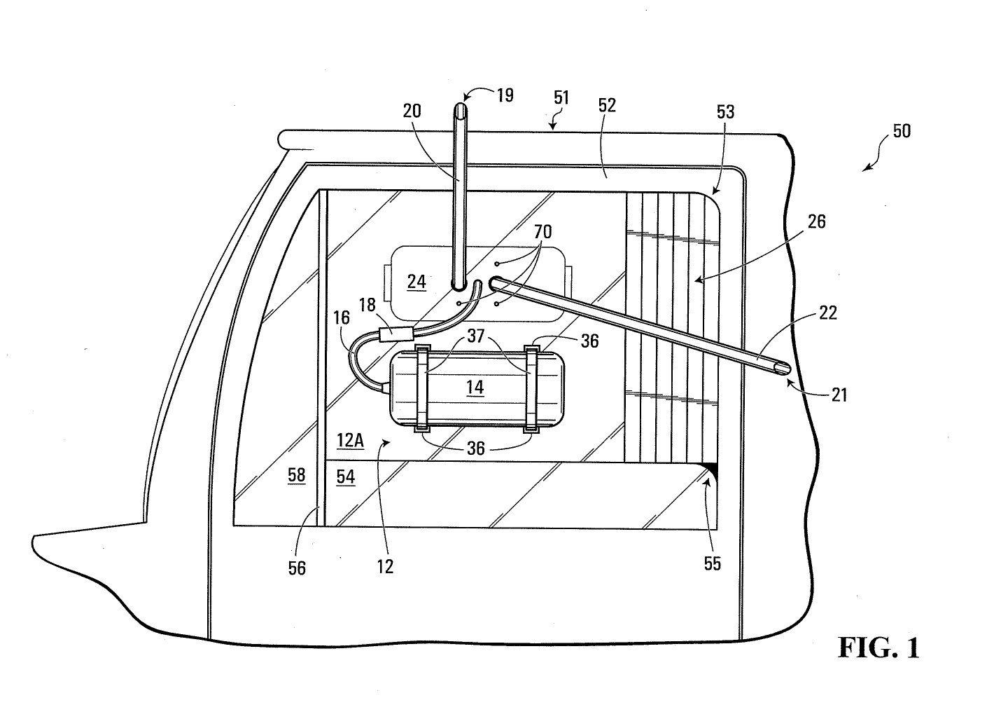

Referring to FIGS. 1 to 3, heating apparatus 10 is shown installed in vehicle window frame 52 of vehicle 50. Heating apparatus 10 may be modular and self-contained having all necessary components attached to its mounting plate 12 to facilitate ready installation in window frame 52.

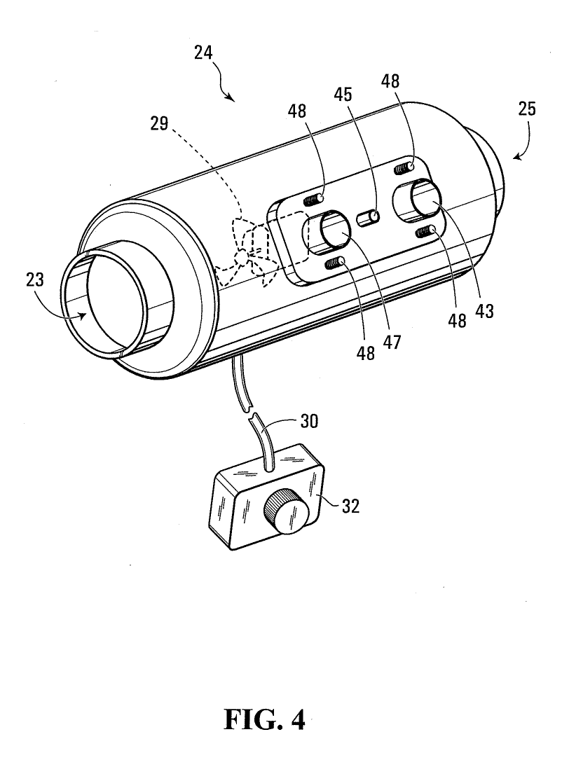

With reference to FIG. 4, combustion heater 24 of the heating apparatus may have a cool air inlet 23 and hot air outlet 25. Combustion heater 24 may be an air heater having an electric fan 29 operative to drawn air into combustion heater 24 through cool air inlet 23, past an internal heat exchanger (not shown), and through hot air outlet 25 to supply heated air to the interior of a vehicle. Combustion heater 24 may also have an air intake 43, fuel supply port 45, and an exhaust port 47. Combustion heater 24 may also have securing bolts 48 used to assist in mounting combustion heater 24 to mounting plate 12. Air intake 43 supplies air for combustion of a fuel that may be supplied to a combustion chamber (not shown) via the fuel supply port 45. Exhaust gases resulting from combustion in the combustion chamber (not shown) of combustion heater 24 are vented from combustion heater 24 via exhaust port 47.

Combustion heater 24 may also have a power line 30 terminating in an adapter 32. Adapter 32 may be configured to be received by a standard cigarette-type lighter socket (not shown) in vehicle 50 (FIG. 1). In this manner, combustion heater 24 may be provided with a source of electric power from the battery of the vehicle to operate its electric fan (not shown) or control system (not shown). Combustion heater 24 should be compatible with the electrical system of a vehicle where heating apparatus 10 is to be installed, which is typically 12V DC in commercial trucks used in North America.

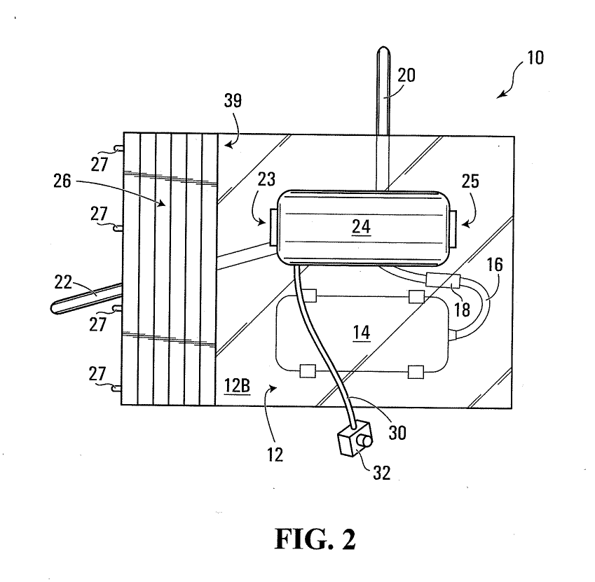

One suitable type of combustion heater 24 is an air heater capable of running on diesel fuel, gasoline, or kerosene. Air heaters having an output of 1 kW to 5 kW should be suitable for most commercial vehicles, with heaters having larger outputs suitable for vehicles having larger interiors. Air heaters are known in the art and may be adapted to be mounted to mounting plate 12 (FIG. 1) with limited modification. One suitable air heater that may be adapted for use with heating apparatus 10 (FIG. 2) is the Airtronic® D2 heater manufactured by Espar Heater Systems.

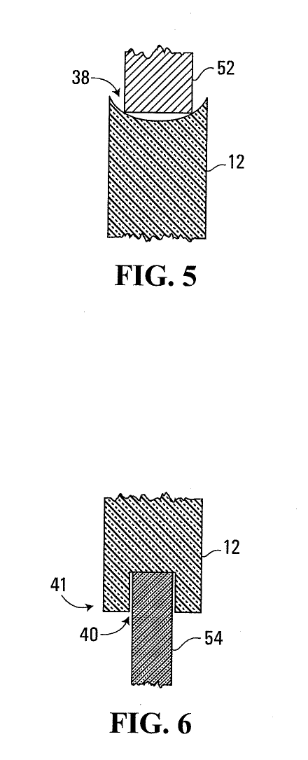

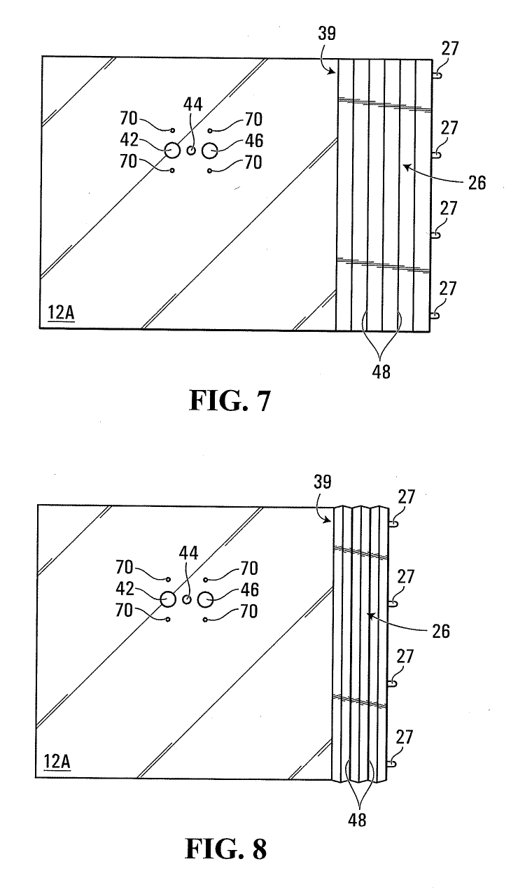

Mounting plate 12 has one or more openings extending from an outside face 12a of the plate to an inside face 12b. For example, as shown in FIGS. 6 and 7, mounting plate 12 may have an intake opening 46, exhaust opening 42, a fuel supply opening 44, and mounting openings 70.

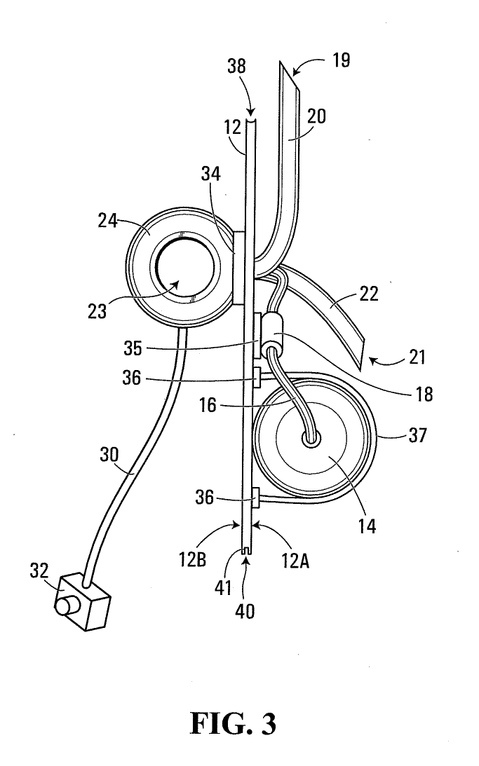

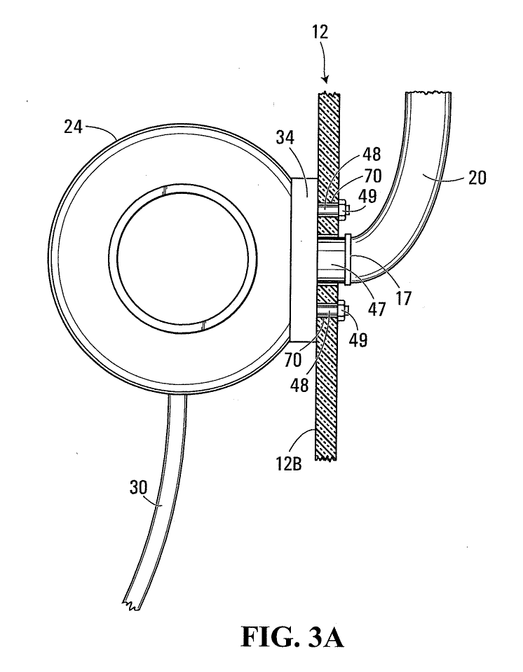

A fuel tank 14 may be attached to outside face 12a of mounting plate 12 using tie straps 37 attached to brackets 36 secured to outside face 12a of mounting plate 12. With reference to FIGS. 3A and 4, combustion heater 24 may be attached to inside face 12b of mounting plate 12 by positioning a mounting adapter 34 of combustion heater 24 against inside face 12b of mounting plate 12, so that the air intake 43, fuel supply port 45, exhaust port 47, and securing bolts 48 extend through a corresponding aperture or corresponding apertures of mounting plate 12. Nuts 49 may then be threaded on to securing bolts 48 to secure combustion heater 24 to mounting plate 12.

Returning to FIGS. 1 to 3, a fuel line 16 may have a fuel pump 18 located between fuel tank 14 and combustion heater 24. The fuel pump may be powered by a power line (not shown) which terminates at adapter 32. Fuel line 16 (and the power line for the fuel pump) may extend through mounting plate fuel supply opening 44 (FIG. 7) to connect the fuel tank 14 to fuel supply port 45 (FIG. 4) of the combustion heater 24, through fuel pump 18. Fuel pump 18 may be mounted to outside face 12a of the mounting plate using mounting bracket 35.

Fuel tank 14 should be of a sufficient size to ensure that combustion heater 24 can be operated overnight. Fuel tank 14 should be designed to be compatible with the fuel burned by combustion heater 24. Using diesel, gasoline, or kerosene as a fuel has been found advantageous as it is readily available and may be safely stored in a lightweight fuel tank 14. Alternatively, other fuels may be used with suitable modifications to combustion heater 24 and fuel tank 14.

Air intake 43 (FIG. 4) of combustion heater 24 may extend through mounting plate intake opening 46 (FIG. 6) and be connected at one end to fresh air conduit 22. Fresh air conduit 22 may terminate at intake end 21 located outside vehicle 50. Similarly, exhaust port 47 (FIG. 4) of combustion heater 24 may extend through mounting plate exhaust opening 42 (FIG. 6), be connected to exhaust conduit 20, and terminate outside vehicle 50 at exhaust end 19. A sealed and secure connection should be provided between exhaust conduit 20 and exhaust port 47 so that exhaust gases are vented outside of vehicle 50 and do not contaminate the vehicle interior. For example, as shown in FIG. 3A, exhaust port 47 may extend through exhaust opening 42 of mounting plate and be secured to exhaust conduit 22 using a hose clamp 17 outside the vehicle cab to reduce the likelihood of harmful exhaust gases entering the vehicle interior.

In one embodiment, exhaust end 19 may be located above intake end 21. In such an arrangement the potential for exhaust gases to enter fresh air conduit 20 is minimized as exhaust gases are typically hotter than the external atmospheric air and therefore tend to rise. For example, exhaust conduit 20 may incline to exhaust end 19 and fresh air conduit 22 may decline to intake 21 so that exhaust end 19 is disposed above intake end 21. Exhaust conduit 20 and fresh air conduit 22 may also extend in laterally opposite directions to reduce the risk that exhaust gases enter fresh air intake 22, for example, as shown in FIG. 1. As a safety feature it may also be desirable to have exhaust end 19 located above roof 51 of vehicle 50 to reduce the risk of exhaust gases entering the vehicle interior. Additionally, having the exhaust conduit extend upwardly, away from the handle of the vehicle door, may reduce the risk of an operator being burned by touching exhaust conduit 20, which may become hot during sustained operation of combustion heater 24.

As shown in FIG. 3, mounting plate 12 may have a concave upper edge 38 and a lower edge 41 with a U-shaped recess 40 to facilitate secure installation of heating apparatus 10 into vehicle window frame 52. Concave upper edge 38 may be adapted to abut the upper portion of the vehicle window frame 52 as depicted in FIG. 5 to substantially prevent air from flowing between upper edge 38 and vehicle window frame 52 to minimize heat loss from the vehicle interior. U-shaped recess 40 may be configured to receive window pane 54 as shown in FIG. 6 in a manner to substantially prevent air flow between window pane 54 and lower edge 41.

Mounting plate 12 should be constructed of a material capable of providing sufficient rigidity to permit heating apparatus 10 to be securely installed into vehicle window frame 52. The material used to construct mounting plate 12 should also be capable of withstanding the heat generated by combustion heater 24. The heat transferred to mounting plate 12 may vary depending upon the particular combustion heater 24 used and the particular mounting adapter 34 that is employed. Consequently, the particular material chosen for mounting plate 10 may vary depending upon the specific application, however, plastics may be considered suitable for most applications.

A laterally extendable wall 26 may be attached to lateral edge 39 of mounting plate 12. Laterally extendable wall 26 is extendable in a lateral direction so that the mounting plate and laterally extendable wall completely fill vehicle window frame 52 and thereby assist in maintaining interior heat. Laterally extendable wall 26 may also have a plurality of hooks 27 to interact with vehicle window frame 52 in order to assist in securing laterally extendable wall 26 in the extended position. Laterally extendable wall 26 thus facilitates installation of heating apparatus 10 into vehicle window frames having different dimensions.

As shown in FIGS. 7 and 8, laterally extendable wall 26 may have a plurality of laterally expandable pleats 48. FIG. 7 depicts the laterally extendable wall 26 with pleats 48 in an extended position while FIG. 7 depicts wall 26 with pleats 48 in a partially retracted position. The laterally extendable wall may be fabricated as a pleated fabric within a peripheral hinged frame. One side of the hinged frame connects to mounting plate 12.

Laterally extendable wall 26 may also have a foam liner (not shown) extending around its periphery to assist in providing a seal between the laterally extendable wall 26 and vehicle window frame 52 when laterally extendable wall 26 is in an extended position. The specific type of foam, its profile, and the method of mounting to laterally extendable wall 26 may be chosen to suit the desired application. It has been found that SC-42 PSA Backing is one suitable material for the foam liner.

With reference to FIG. 1, in certain types of commercial vehicles, such as commercial trucks, the size of the vehicle window frame 52 does not vary significantly between different models. In particular, the size and dimensions of vehicle window frames in commercial trucks are relatively constant with the exception of variations in the curvature and dimensions of the rear top corner section 53 of vehicle window frame 52. If variations in top corner section 53 are accounted for, heating apparatus 10 may be installed in a wide variety of vehicles and still fill the window opening.

A typical vehicle window found in commercial trucks is illustrated in FIG. 1. The vehicle window frame 52 extends around the exterior of the window opening. Extending from one edge of vehicle window frame 52 is a front window pane 58 which is secured between one edge of vehicle window frame 52 and stanchion 56. A main window pane 54 may have a curved rear top corner 55 to correspond to the curvature of top corner section 53 of vehicle window frame 52. Main window pane 54 may extend between stanchion 56 and a rear edge of vehicle window frame 52 and may be lowered or raised to allow the window to be opened and closed.

As previously noted, any significant variation between different commercial trucks typically occurs at or near rear top corner section 53 of vehicle window frame 52 and corresponding rear top corner 55 of window pane 54. As a result, heating assembly 10 having a laterally extendable wall 26 may be installed in vehicle window frames of different sizes by extending the laterally extendable wall 26 an appropriate lateral distance to abut vehicle window frame 52. Laterally extendable wall may also have a foam wall extension (not shown) which conforms to the shape of rear top corner 53 of the window frame and fills the remainder of the window opening.

It will be apparent that heating apparatus 10 may be readily installed in vehicle window frames of different heights. More specifically, any variation of height between vehicle window frames may be accounted for by raising main window pane 54 to raise mounting plate 12 until its concave upper edge 38 abuts the top of vehicle window frame 52.

Heating apparatus 10 may also be designed to generally balance the weight of components attached to the outside face 12a and inside face 12b of mounting plate 12, at least when the fuel tank is full. Although the weight of fuel tank 14 changes as fuel is consumed, balancing the load attached to both sides of mounting plate 12 when the fuel tank is full promotes easier installation of heating apparatus 10 into vehicle window frame 52.

To install heating apparatus 10, with the window substantially open so that the top of window pane 54 is present in the window opening, mounting plate 12 may be inserted into vehicle window frame 52 and held in a vertical position with mounting plate side 12b on the inside of the vehicle and with the lower U-shaped recess 40 of the mounting plate receiving window pane 54. Window pane 54 may then be raised until the concave upper edge 38 of the mounting plate 12 abuts the top of vehicle window frame 52. The heating apparatus 10 is now held in vehicle window frame 52. Laterally extendable wall 26 may then be extended so that its foam liner (or foam wall extension) fills the rear portion of the vehicle window frame 52 above window pane 54. In this manner, heating apparatus 10 may be efficiently installed in windows of varying sizes and shapes without permanent modification to a vehicle.

Next, the adapter 32 may be plugged into a cigarette-lighter type socket inside the vehicle 50 to provide a source of electrical power from the vehicle battery to the combustion heater 24 and fuel pump 18. In this manner, electricity can be supplied to heating apparatus 10 without requiring operation of the vehicle's engine.

In operation, fuel may be supplied to combustion heater 24 from fuel tank 14 by fuel pump 18 via fuel line 16 so that fuel can be burned within the combustion chamber (not shown) of the combustion heater 24. Fresh air may be supplied to the combustion chamber of combustion heater 24 via fresh air intake 22. Exhaust gases may be vented from combustion chamber of combustion heater via exhaust conduit 20. A fan of combustion heater 24 may operate to draw air into cool air inlet 23, past a heat exchanger (not shown) that may be heated by a combustion chamber, to warm air before it is expelled from combustion heater 24 via hot air outlet 25. In this manner, heat may be provided to the vehicle interior to maintain a comfortable interior temperature without operating the engine of a vehicle.

Mounting fuel tank 14 to the outside face 12a of mounting plate 12 may reduce the risk of injury to a vehicle occupant should the fuel within fuel tank 14 accidentally be ignited. Similarly, having fuel tank 14 mounted to outside face 12a reduces the risk that fuel vapors will accumulate inside the vehicle interior should a leak occur in the fuel tank 14, fuel line 16, or at the connection between the fuel tank 14 and fuel line 16. Similarly, having fuel pump 18 located outside the vehicle reduces the risk of fuel or fuel vapors contaminating the vehicle in the event that leaks between the fuel pump 18 and fuel line 16 occur. Additionally, having fuel pump 18 located outside vehicle 50 may increase the operating life of fuel pump 18 as it is not exposed to significant radiant heat present in the vicinity of the combustion heater 24.

Manufacturing and inventory costs may be reduced by having one model of heating apparatus 10 that may be used in a wide variety of vehicles. Additionally, the ability to install heating apparatus 10 in a wide variety of vehicles may increase the marketability of the heating apparatus 10 compared to other known portable heating systems. For example, fleets of commercial vehicles that do not regularly operate in cold weather and would not install permanent fuel operated heater systems, may be interested in heating apparatus 10. These commercial fleets may purchase a number of heaters for use by drivers planning to travel in cold weather.

Similarly, anti-idling truck stops may be interested in purchasing a number of heater assemblies 10 to lease to drivers staying overnight at the facility. The heater assemblies 10 could be an alternative to constructing electrified truck stations or could provide a more flexible capacity to a truck stop with electrified truck stations.

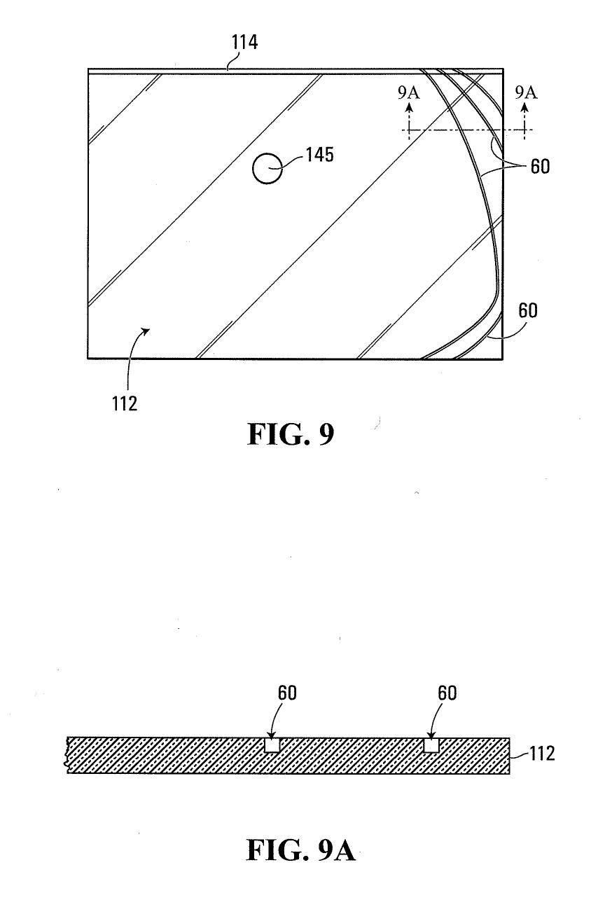

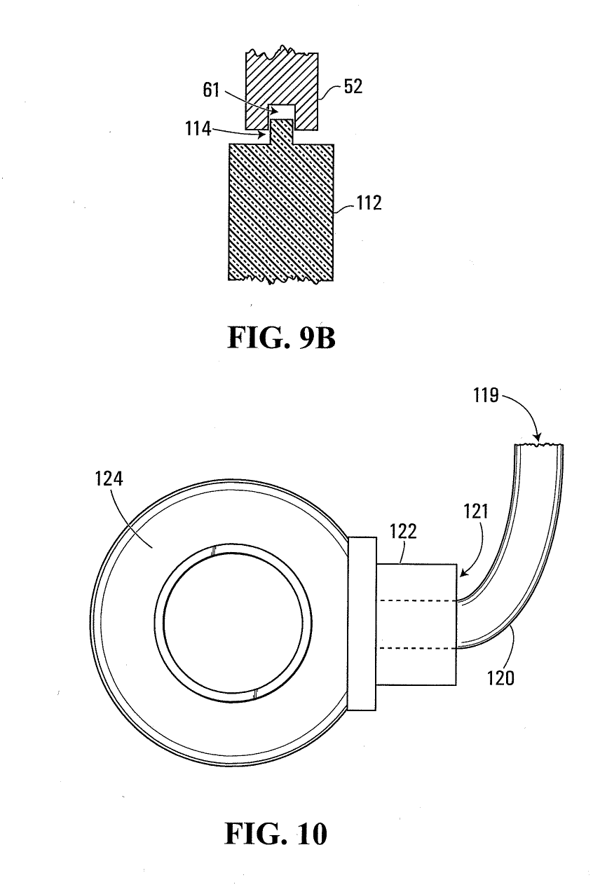

An alternative mounting plate 112 is depicted in FIG. 9. Mounting plate 112 may have a plurality of score lines 60 to facilitate installation of mounting plate 112 into windows having different sizes. Score lines 60 may be comprised of a recessed groove extending partially through mounting plate 112 as shown in FIG. 8A. Score lines should be recessed to an appropriate depth to facilitate cutting of mounting plate 112 to an appropriate size while ensuring that sufficient strength is maintain if a particular score line 60 is not cut. The depth of score lines 60 may vary depending upon the material used to construct mounting plate 112, as will be understood by persons skilled in the art.

Mounting plate 112 may then be configured to correspond to certain common window frame shapes by cutting along an appropriate score line 60 to selectively remove sections of mounting plate 112 so that mounting plate 112 fits vehicle window frame 52. In this embodiment, a laterally extendable wall is not used. A manufacturer of a heating assembly with plate 112 may offer a product that may be customized by customers for their vehicles. Inventory and manufacturing costs are therefore reduced when score lines are used in comparison to precut mounting plates of different dimensions.

With reference to FIG. 10, in an alternative embodiment, a combustion heater 124 may have a co-axial air intake and combustion exhaust. In such instance, as shown in FIG. 9, mounting plate 112 may have a single opening 145 acting as both an intake opening and exhaust opening. Fuel may also be supplied through the intake opening.

The co-axial arrangement of the air intake opening and exhaust opening may improve the efficiency of the combustion heater. In the co-axial arrangement, air passing through fresh air conduit 122 and through the air intake is heated by air passing through co-axial exhaust conduit 120, which may improve the efficiency of the combustion heater. With co-axial air intake and exhaust conduits, if the exhaust conduit 120 is the smaller diameter inner conduit, the exhaust end 119 may extend beyond the end 121 of the air intake conduit 122 and be oriented to reduce the likelihood of exhaust gases entering the fresh air conduit.

The upper edge of mounting plate 112 may also have a central blade 114 extending along at least part of the upper edge. Projection 114 may be received by slot 61 of vehicle window frame 52 to secure mounting plate 112 in vehicle window frame 52 and to substantially prevent air from flowing between projection 114 and vehicle window frame 52 to minimize heat loss. Similarly, mounting plate 12 could be modified to have a similar projection on its upper edge to be received by a slot of the vehicle window frame to assist in securing heating apparatus 10 as an alternative to concave upper edge 38 as previously described.

The vehicle in which the heating apparatus 10 is mounted may be any type of vehicle which has a cab with a window frame, such as a commercial vehicle (e.g., a truck), automotive vehicle (e.g., a car), off-road vehicle (e.g., a crane) or boat.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Of course, the above described embodiments, are intended to be illustrative only and in no way limiting. The described embodiments of carrying out the invention, are susceptible to many modifications of form, arrangement of parts, details and order of operation. The invention, rather, is intended to encompass all such modification within its scope, as defined by the claims.

What is claimed is:

1. Apparatus for heating a vehicle, comprising:
a mounting plate adapted to be secured in a window frame of said vehicle, said mounting plate having an inside face, an opposed outside face, and at least one opening extending between said outside face and said inside face;
a combustion heater mounted to said inside face of said mounting plate, said combustion heater arranged to intake fresh air through one opening of said at least one opening and expel exhaust through one opening of said at least one opening;
a fuel tank mounted to said outside face of said mounting plate and a fuel line extending through one opening of said at least one opening to connect said fuel tank with a fuel inlet of said combustion heater.

2. The apparatus of claim 1 further comprising a fuel pump in said fuel line, said fuel pump at said outside face of said mounting plate.

3. The apparatus of claim 2 wherein said mounting plate has a lower edge, said lower edge having a U-shaped groove to receive the top edge of a window pane.

4. The apparatus of claim 3 wherein said mounting plate has a concave upper edge adapted to abut the top edge of said vehicle window frame.

5. The apparatus of claim 3 wherein said mounting plate has an upper edge having a centrally located blade extending from said upper edge to be received by a slot of said vehicle window frame.

6. The apparatus of claim 1 wherein said at least one opening comprises a first opening and a second opening and wherein said combustion heater further comprises:
an intake port connected to a fresh air conduit, said intake port and said fresh air conduit providing a passage through said first opening to supply fresh air to said combustion heater through said mounting plate; and
an exhaust port connected to an exhaust conduit, said exhaust port and said exhaust conduit providing a passage through said second opening to exhaust combustion gases from said combustion heater through said mounting plate.

7. The apparatus of claim 6 wherein said fresh air conduit extends to an intake end and said exhaust conduit extends to an exhaust end, said intake end disposed below said exhaust end when said mounting plate is installed in said window frame of said vehicle.

8. The apparatus of claim 7 wherein said fresh air conduit has a conduit section declining from said first opening to said intake end and wherein said exhaust conduit has an conduit section inclining from said second opening to said exhaust end.

9. The apparatus of claim 8 wherein said at least one opening further comprises a third opening and wherein said fuel line extends through said third opening.

10. The apparatus of claim 2 further comprising a laterally extendable wall attached to said mounting plate at a lateral edge of said mounting plate to allow said wall to extend from said lateral edge of said mounting plate to a lateral side of said vehicle window frame.

11. The apparatus of claim 10 wherein said laterally extending wall has laterally expandable pleats.

12. The apparatus of claim 2 wherein said mounting plate has a plurality of score lines defining removable sections of said mounting plate whereby selective sections of said mounting plate may be removed so that said mounting plate fits said vehicle window frame.

13. The apparatus of claim 2 wherein said combustion heater has an electric fan to circulate air through said heater.

14. The apparatus of claim 13 further comprising a power line for connecting said electric fan and said fuel pump to a battery of said vehicle.

15. The apparatus of claim 14 wherein said power line terminates in an adapter for reception in a cigarette-type lighter socket of said vehicle.

16. The apparatus of claim 1 further comprising a fresh air conduit and a co-axially positioned exhaust conduit, said fresh air conduit and said exhaust conduit both extending through said at least one opening of said mounting plate, wherein;
said fresh air conduit is connected to an air intake of said combustion heater to supply fresh air to said combustion heater through said at least one opening; and
said exhaust conduit is connected to an exhaust port of said combustion heater to exhaust combustion gases through said at least one opening.

17. The apparatus of claim 16, wherein said exhaust conduit is positioned within said fresh air conduit.

18. The apparatus of claim 17, wherein said exhaust conduit extends to an exhaust end and said fresh air conduit extends to an intake end; said exhaust conduit being longer than said fresh air conduit so that said exhaust end extends beyond said intake end.
